(19) United States
(12) Patent Application Publication
(10) Pub. No.: US 2008/0266181 A1
(43) Pub. Date: Oct. 30, 2008

(54) Antenna Arrangement

(76) Inventor: Zhinong Ying, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/910,537

(22) PCT Filed: Apr. 5, 2006
(86) PCT No.: PCT/EP2006/061316

§ 371 Date: Jun. 17, 2008

Related U.S. Application Data
(60) Provisional application No. 60/671,270, filed on Apr. 14, 2005.

(30) Foreign Application Priority Data
Apr. 7, 2005 (EP) 05102752.2

(51) Int. Cl. H01Q 9/04

(52) U.S. Cl. 343/700 MS

(57) ABSTRACT

An antenna arrangement (1, 30), comprising a first and a second antenna. The first antenna has a patch (10) of conductive material. The second antenna comprises a monopole antenna (21, 32). The monopole antenna extends through the patch and is arranged to be fed from a first side of the patch and to radiate at a second side of the patch. The antenna arrangement is a multiple-input, multiple-output (MIMO) system, wherein the patch (10) and the monopole antenna (21, 32) are isolated from each other and arranged to provide at least two channels for transmitting and receiving signals from the same or different frequency ranges. Thus, the antenna arrangement is efficient both in terms of utilization and achievable data rates.

### TECHNICAL FIELD OF THE INVENTION

The present invention relates to an antenna arrangement comprising multiple antennas in multiple-output (MIMO) antenna systems.

### DESCRIPTION OF RELATED ART

In wireless communication environments, the need for support of high data rates is constantly increasing. In addition, the requirement of quality of reception or transmission of the signals is ever increasing. Multiple-input, multiple-output (MIMO) antenna systems may be used for increasing the capacity and coverage for the communication systems. The MIMO antenna systems comprise multiple antennas for providing spatial multiplexing and/or reception and transmission diversity.

In spatial multiplexing, multiple data streams are transmitted concurrently from multiple antennas and/or received by multiple antennas. Consequently, the data rate achieved is dependent on the number of antennas used in the antenna system.

In transmit diversity, the same data stream is transmitted from and/or received by multiple antennas providing correlated channels. The quality of the transmission will increase with increased number of antennas.

In a portable wireless communication apparatus, the space within the housing, which is dedicated for an antenna arrangement, may be limited for an internal antenna system. Therefore, it is a problem to use an internal MIMO antenna system, as it may be too bulky to fit within the housing of the apparatus. Furthermore, employing multiple antennas may also be costly.

The PATENT ABSTRACTS OF JAPAN, vol. 2003, no. 12, 5 Dec. 2003 and the corresponding JP 2005 020301, 20 Jan. 2005, disclose an antenna assembly having multiple antennas. The antenna assembly of D1 has structural similarities with the antenna arrangement of the invention. However, one antenna of D1 is a circularly-polarized wave antenna that is configured to receive radio waves transmitted from a satellite, and has directivity upwards. A second antenna of the antenna assembly of D1 is a monopole vertically polarized wave antenna configured to receive radio waves from ground radio facilities.

EP 0 590 955 A (LORAL AEROSPACE CORPORATION; LORAL AEROSPACE CORP) discloses a multiband antenna having multiple antennas integrated in an antenna assembly. This application is not related to MIMO antenna systems. The antenna assembly is configured for reception of radio signals in different frequency bands, corresponding to different antenna sub-systems of an antenna assembly, respectively, for instance GPS and telephone or radio (AM/FM) signals.

U.S. Pat. No. 6,313,801 B1 (Telefonaktiebolaget L M Ericsson; SANFORD GARY GEORGE ET AL), discloses an antenna structure including multiple antennas. However, this document is not related to MIMO antenna systems. The antenna assembly is configured for reception of radio signals in different frequency bands, corresponding to different antenna sub-systems of an antenna assembly, for GPS and telephone communication signals, respectively.

U.S. Pat. No. 5,434,580 A (RAGUENET ET AL), discloses a multi-band antenna assembly having an array of two radiating elements acting in two different frequency ranges. However, this document is not related to MIMO antenna systems.

In the article “Reviewing SDARS Antenna Requirements” MICROWAVE & RF, September 2003 (2003-09), pages 51-62, XP002354971 by PETROS A, ZAFAR I, LICUL S, antenna assemblies of a similar type as in U.S. Pat. No. 6,313,801 B1 is disclosed. Again, this disclosure is not related to the MIMO antenna systems.

Hence, an improved MIMO antenna system would be advantageous.

### SUMMARY OF THE INVENTION

It is an object of the invention to provide an efficient MIMO antenna system.

According to first aspect, an antenna arrangement, comprises a first antenna and a second antenna extending through and on a first and second side thereof, wherein the first antenna comprises a patch of conductive material, and the second antenna comprises a monopole antenna, wherein the arrangement is a multiple-input, multiple-output (MIMO) system, and where the patch and the monopole antenna are isolated from each other and arranged to provide at least two channels for transmitting and receiving signals from the same or different frequency ranges.

Further on the monopole antenna may comprise a conductor. The antenna may also be arranged to be fed from a first side of the patch and to radiate at a second side of the patch. The monopole antenna may be extended on the second side of the patch such as a normal relative the extension of the patch. Further the monopole antenna may have an omnicircular radiation pattern. The monopole antenna may be a straight conductor, a helical, a meandering or a cone monopole antenna.

The first antenna may be a planar patch antenna, wherein the patch may comprises a first feeding point for feeding the first antenna, thus providing a first channel for transmitting and receiving signals. The first antenna may be a dual polarized patch antenna having feeding points for feeding the first antenna, thus providing a first and a second channel for transmitting and receiving signals, wherein the feeding points are orthogonally positioned at the patch, wherein an orthogonal radiation pattern may be obtained in the same frequency range. The feeding points may be connected to a transmission/reception circuitry for feeding the first antenna. A connector, which may be connected to the transmission/reception circuitry, may be soldered to the first antenna at each of the feeding points.

Further on the second antenna may comprises a coaxial cable having a concentrically located conductor and a conducting shield connected to ground, the concentrically located conductor being arranged to act as the monopole antenna, and the conducting shield being connected to the patch.

The monopole antenna may extend through a recess of the patch at a center thereof. The diameter of the recess may be larger than the diameter of the monopole antenna, thus the antenna freely extends through the patch without contacting the patch, wherein the isolation between the first and the second antenna is achieved.

The length of the exposed portion of the monopole antenna may correspond to ¼ of the wavelength of the signal for which the second antenna is tuned.

The antenna arrangement may also comprise a top load element at a free end of the monopole antenna, wherein the shape of the top load element may be of a circular, helical, meandering, square/rectangular or conical shape. The diameter of a circular top load element may be substantially a ¼ of the wavelength for which the antenna is tuned and the length of the exposed portion of the monopole antenna may correspond to 1/10 to 1/20 of the wavelength for which the second antenna is tuned.

The patch may be provided on a separate dielectric support element or the patch may be provided integrally with the dielectric support element. Etching, printing or screen-printing of the conductive material on the support element, may provide the patch. The patch and a ground plane may be separated by a dielectric substrate or the support element may be used as the dielectric substrate, where the ground plane is arranged on a first side of the substrate and the patch is arranged on a second side of the substrate. The shape of the patch may be a circular, an elliptical, a dipole, a circular ring, a square, a rectangular or a triangular shape.

According to a second aspect, a wireless communication apparatus comprises the antenna arrangement.

The wireless communication apparatus may be portable. The wireless communication apparatus may be a computer, portable radio communication equipment, a mobile radio terminal, a pager, a communicator, an electronic organizer, a personal digital assistant, a handheld device or a Smartphone.

Further embodiments of the invention are defined in the dependent claims.

It is an advantage of the antenna arrangement according to the invention that it is efficient both in terms of utilization as well as achievable data rates.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Further objects, features and advantages of the invention will appear from the following detailed description of the invention, reference being made to the accompanying drawings, in which:

FIG. 1 is a perspective view a first embodiment of the antenna arrangement;

FIG. 3 is a top view of the antenna arrangement of FIG. 1;

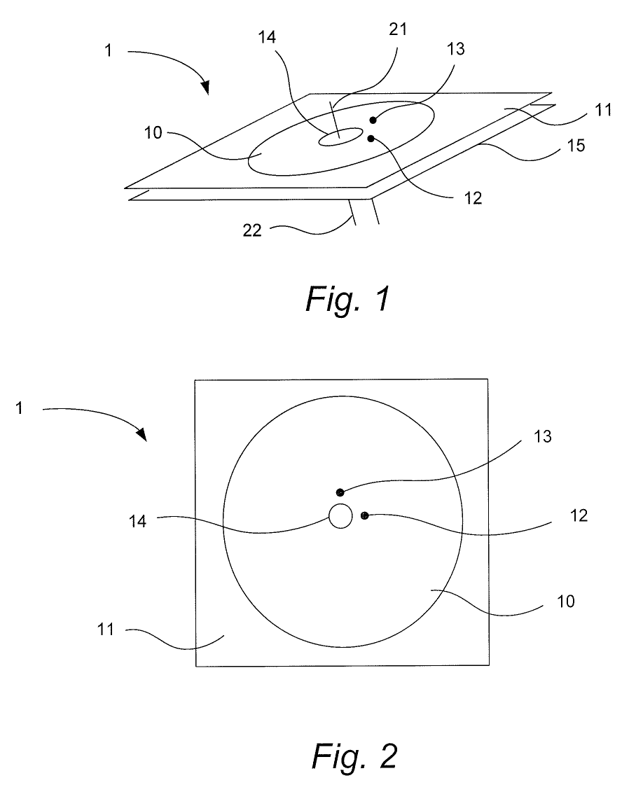

FIG. 2 is side view of the antenna arrangement of FIG. 1; and

FIG. 4 is a perspective view of a second embodiment of the antenna arrangement.

### DETAILED DESCRIPTION OF EMBODIMENTS

FIG. 1 illustrates an antenna arrangement 1 according to the invention. The antenna arrangement 1 comprises a first antenna and a second antenna extending through and on a first and a second side thereof. The second antenna is arranged to be fed from a first side of the first antenna and to radiate on a second side of the first antenna.

The first antenna comprises a patch of a conducting material, such as copper. The patch 10 may be provided on a separate dielectric support element 11. The patch 10 may e.g. be provided by etching, printing, screen printing, etc. the conductive material on the support element 11. Alternatively, the support element 11 may be provided integrally with the patch 10. A sheet of conducting material such as metal, e.g. copper, may form the patch 10, wherein the support element 11 is formed integral therewith, thus a separate support element is unnecessary if the thickness of the patch 10 is sufficient to be self-supporting.

FIG. 2 discloses feeding points of the first antenna. In a first embodiment, the patch 10 comprises a first feeding point 12 for feeding the first antenna. Thus, the first antenna may provide a first channel for transmitting and receiving signals.

In another embodiment, the first antenna comprises, in addition to the first feeding point 12, a second feeding point 13 for feeding the patch 10. Thus the first antenna may provide a second channel for transmitting and receiving signals. FIG. 2 illustrates the first and the second feeding points 12, 13. However, any of them may be excluded, wherein only one channel will be provided.

By arranging two feeding pins, two separate transmission channels may be achieved being separate and orthogonal.

Each feeding point 12, 13 may be connected to transmission/reception circuitry, for feeding the first antenna. Alternatively, a connector, which is connected to the transmission/reception circuitry is soldered to the first antenna 1 at each feeding point 12, 13. The pin, or the connector, may extend through a slot in the support element 11 (not shown).

In one embodiment wherein two feeding points are provided, the first antenna is a dual polarized patch antenna. In this embodiment, the first and the second feeding point 12, 13 are positioned orthogonally relative each other, wherein an orthogonal radiation pattern may be obtained in the same frequency range. Consequently, two channels for spatial multiplexing of transmission/reception within the same frequency range may be provided, thereby providing two uncorrelated channels, wherein the transmission capacity is increased compared to having only one feeding point.

The first antenna may be in the form of a dual polarized patch antenna, which may provide two independent uncorrelated space channels with very low mutual coupling.

The patch 10 of the first antenna may be provided opposite a ground plane 15. The patch 10 and the ground plane 15 may be separated by a dielectric substrate, such as air, plastic, a portion of a PCB (Printed Circuit Board), or a ceramic material. The support element 11 may be used as the dielectric substrate, in which case, the ground plane is arranged on a first side, such as the bottom side, of the substrate and the patch antenna is arranged on a second side, such as topside, of the substrate.

Each feeding point 12, 13 of the first antenna may be fed by means of a coaxial cable having a conductor connected to the feeding point 12, 13 and a shield connected to the ground plane 15.

The antenna arrangement 1 further comprises, according to the invention, a second antenna being a monopole antenna 21. The monopole antenna 21 may be fed from a first side of the patch 10 and radiate on a second side of the patch 10. The monopole antenna may extend on the second side of the patch 10 such as normal relative the extension of the patch 10. Other directions are also feasible. The monopole antenna 21 may have an omnicircular radiation pattern.

In one embodiment, the monopole antenna 21 extends substantially orthogonally relative the extension of the first antenna 10. The monopole antenna may e.g. be a straight conductor, a helical, a meandering or a cone monopole antenna.

The monopole antenna 21 may extend through the patch 10 and be arranged to be fed from a first side of the patch 10 and to radiate on a second side of the patch 10. The second antenna may provide transmission/reception in a different or in the same frequency range as the first antenna. Thus, an additional channel for diversity transmission/reception or an additional uncorrelated channel may be provided by the second antenna.

It is an advantage of the antenna arrangement according to FIGS. 1-2 that antenna diversity with up to three separate channels may be provided for transmission in the same or different frequency ranges, thereby supporting high data rates and increased quality obtained by diversity.

The monopole antenna 21 or a feeding portion thereof may extend through a recess or opening 14 in the support element 11 and the patch 10. The diameter of the recess 14 is larger than the diameter of a conductor of the monopole antenna 21. Thus, the conductor will freely extend through the patch 10 without contacting it, wherein the isolation between the first and the second antenna will be achieved. The recess or opening 14 does not disturb the operation of the first antenna arrangement.

As the monopole antenna 21 of the second antenna extends in a vertical direction relative the extension of the patch 10, good radiation isolation between the first and the second antenna will be achieved.

The monopole antenna 21 may comprise a coaxial cable 22 having a concentrically located conductor and a conducting shield. The concentrically located conductor may be used as the monopole antenna 21, which may be arranged to freely extend out of the conducting shield of the coaxial cable and through the support element 11. The conducting shield may be connected to the ground plane 15 as well as to the patch 10. The conducting shield may at least partly extend though the recess 14, such that a tight fit is obtained between the conducting shield and the patch 10. Alternatively, the conducting shield ends at and contacts the patch 10 at the surface thereof.

The recess 14 or opening may connect the centre of the patch to the ground plane. This will not disturb the operation of the patch antenna appreciably. The shield of the second antenna is then connected to the opening and the ground plane.

By connecting the conductive shield of the second antenna to the patch, the isolation between the first and the second antenna may be further improved.

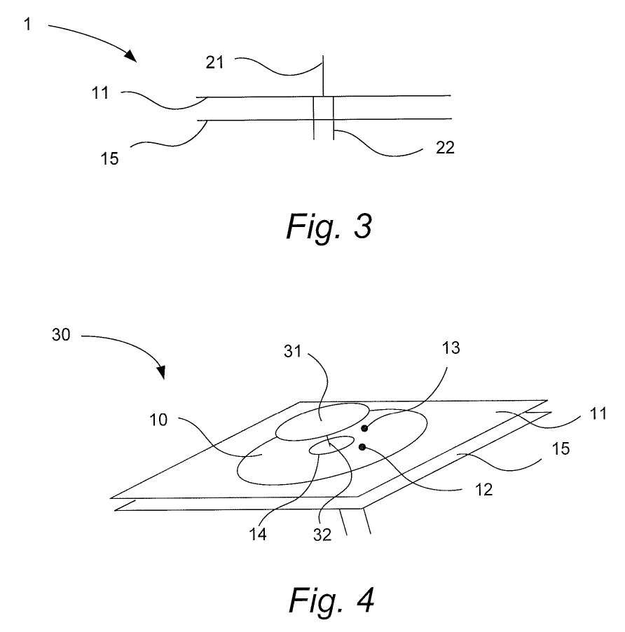

The recess 14 may be provided anywhere in the patch 10. However, in one embodiment (shown in FIGS. 1-3) the recess 14 is provided at the center of the patch 10. This has the advantage that the interference between the first and the second antenna will be at a minimum if the monopole antenna 21 is provided substantially at the center of the recess 14, i.e. at the center of patch 10.

FIG. 4 discloses another embodiment of the antenna arrangement 30. Components corresponding to the embodiments of FIGS. 1-3 are denoted by the same reference numerals. A top load element 31 or dielectric loading is connected to a free end of the monopole antenna 32. The top load element 31 may have another shape, such as a helical, a meandering, a square/rectangular, or a conical shape. The embodiment of FIG. 4 has the advantage that the length of an exposed portion of the monopole antenna 21, 32, i.e. from the patch 10 to the free end or the top thereof, may be reduced. The length of the exposed portion of the monopole antenna 21 in the embodiment of FIGS. 1-3, correspond to ¼ of the wavelength of the signal for which the second antenna is tuned. In the embodiment of FIG. 4, the corresponding length of the monopole antenna 32 may be reduced to approximately 1/10- 1/20 of the wavelength of the signal for which the second antenna is tuned. The actual length of the exposed portion of the monopole antenna 32 is dependent on the size, such as the area or the diameter of the top load element 31, the height of the top load element above the patch 10, and the dielectrical constant of the dielectrical material separating the patch 10 and the ground plane 15.

The diameter of the circular top load element 31 may e.g. be substantially a ¼ of the wavelength for which the antenna is tuned.

The embodiments of FIGS. 1-3, i.e. the second antenna without top load element 31, has the advantage of providing larger bandwidth compared to the embodiment of FIG. 4, due to lower SWR (Standing Wave Ratio).

The patch 10 is shown as circular in the embodiments of FIGS. 1-4. However, the patch 10 may have any other shape, such as, elliptical, dipole, circular ring, or polygonal, e.g. square, rectangular or triangular. The shape of the patch 10 has to be tested and evaluated in each specific implementation. For a patch being square/circular, the length of the sides/diameter of the patch 10 substantially corresponds to ½ wavelength of the signal for which the second antenna is tuned. However, the type of material, or dielectrical constant, of the dielectrical material separating the patch 10 and the ground plane 15, may affect the dimensions of the patch. For example, the dimensions of the patch 10 may be reduced if a ceramic material rather than air is used as the dielectrical material.

The input impedance of the antenna arrangement may be matched to the circuitry to which it is connected. The input impedance of the first antenna may be set by the positioning of the feeding points 12, 13 relative the centre of the patch 10. The distance between the centre of the patch 10 and each of the feeding points 12, 13 sets the input impedance of the first antenna. The input impedance of the second antenna may be set by the choice of conductor, such as a 50Ω coaxial cable. The input impedance of the antenna arrangement 1 may be set to 50Ω.

In FIGS. 1-4, the area of the support element 11 is shown as being larger than the area of the patch 10. However, the shape of the support element 11 may conform to the shape of the patch 10.

The present invention may be incorporated into any wireless communication apparatus. Due to its space saving design it could be useful in a portable wireless communication apparatus, such as a computer, a portable or handheld radio communication equipment, a mobile radio terminal, a pager, a communicator, an electronic organizer, a personal digital assistant, a handheld device or a Smartphone. The antenna arrangement could also be useful in communication equipment operating in a wireless local area network, such as office apparatuses, e.g. printers, scanners, or copying machines.

The antenna arrangement according to the invention may be tuned for use in any frequency range, depending on the space available. In a portable electronic device, it may e.g. be used in the frequency range from around 2 GHz and higher. The antenna arrangement may e.g. be useful in a W-LAN (Wireless Local Area Network), or a 3G (3^{rd} generation) or 4G (4^{th} Generation) telecommunication network.

The antenna arrangement according to the invention may be used for providing up to three uncorrelated channels for transmitting/receiving data. Alternatively, the antenna arrangement can be used for providing spatial antenna diversity for correlated channels. Due to the low mutual coupling between the first and the second antenna, the antenna efficiency will be high. The antenna arrangement may be used for data transmissions in the range of 100 Mbit/s if it is configured for providing three uncorrelated channels. The actual data rate is dependent on the actual configuration of the antenna arrangement 1, 30 and may be higher as well as lower.

Simulations of the antenna arrangement according to the embodiment of FIG. 1 have shown that the isolation between the antennas are more than 25 dB, and thus provides good efficiency.

The present invention has been described above with reference to specific embodiments. However, other embodiments than the above described are equally possible within the scope of the invention. The different features of the invention may be combined in other combinations than those described. The scope of the invention is only limited by the appended patent claims.

1. An antenna arrangement (1, 30), comprising a first antenna and a second antenna extending through and on a first and second side thereof, wherein the first antenna comprises a patch (10) of conductive material, and the second antenna comprises a monopole antenna (21, 32), characterized in that said antenna arrangement is a multiple-input, multiple-output (MIMO) system, wherein the patch (10) and the monopole antenna (21, 32) are isolated from each other and arranged to provide at least two channels for transmitting and receiving signals from the same or different frequency ranges.

2. The antenna arrangement according to claim 1, wherein the monopole antenna comprises a conductor.

3. The antenna arrangement according to claim 1 or 2, wherein the monopole antenna (21, 32) is arranged to be fed from a first side of the patch (10) and to radiate at a second side of the patch.

4. The antenna arrangement according to claim 3, wherein the monopole antenna (21, 32) is extended on the second side of the patch (10) such as a normal relative the extension of the patch (10).

5. The antenna arrangement according to any of the previous claims, wherein the monopole antenna is having an omnicircular radiation pattern.

6. The antenna arrangement according to any of the previous claims, wherein the monopole antenna is a straight conductor, a helical, a meandering or a cone monopole antenna.

7. The antenna arrangement according to any of the previous claims, wherein the first antenna is a planar patch antenna.

8. The antenna arrangement according to claim 7, wherein the patch (10) comprises a first feeding point (12) for feeding the first antenna, thus providing a first channel for transmitting and receiving signals.

9. The antenna arrangement according to any of the previous claims, wherein the first antenna is a dual polarized patch antenna having feeding points (12, 13), for feeding the first antenna, thus providing a first and a second channel for transmitting and receiving signals, wherein the feeding points are orthogonally positioned at the patch (10).

10. The antenna arrangement according to claim 9, wherein an orthogonal radiation pattern is obtained in the same frequency range.

11. The antenna arrangement according to any of the previous claims, wherein the feeding points (12, 13) is connected to a transmission/reception circuitry for feeding the first antenna.

12. The antenna arrangement according to any of the previous claims, wherein a connector, which is connected to a transmission/reception circuitry, is soldered to the first antenna at each of said feeding points (12, 13).

13. The antenna arrangement according to any of the previous claims, wherein the second antenna comprises a coaxial cable (22) having a concentrically located conductor and a conducting shield connected to ground, the concentrically located conductor being arranged to act as the monopole antenna (21, 32), and the conducting shield being connected to the patch (10).

14. The antenna arrangement according to any of the previous claims, wherein the monopole antenna (21, 32) extends through a recess (14) of the patch (10) at a center thereof.

15. The antenna arrangement according to any of the previous claims, the diameter of the recess (14) is larger than the diameter of the monopole antenna (21), thus the antenna freely extends through the patch (10) without contacting the patch, wherein the isolation between the first and the second antenna is achieved.

16. The antenna arrangement according to any of the previous claims, wherein the length of the exposed portion of the monopole antenna corresponds to ¼ of the wavelength of the signal for which the second antenna is tuned.

17. The antenna arrangement according to any of the previous claims, further comprising a top load element (31) at a free end of the monopole antenna (32).

18. The antenna arrangement according to claim 17, wherein the shape of the top load element is a circular, helical, meandering, square/rectangular or conical shape.

19. The antenna arrangement according to claim 17 or 18, wherein the diameter of a circular top load element is substantially a ¼ of the wavelength for which the antenna is tuned.

20. The antenna arrangement according to any of claims 17 to 19, wherein the length of the exposed portion of the monopole antenna corresponds to 1/10 to 1/20 of the wavelength for which the second antenna is tuned.

21. The antenna arrangement according to any of the previous claims, wherein the patch (10) is provided on a separate dielectric support element (11).

22. The antenna arrangement according to claim 20, wherein the patch (10) is provided integrally with the dielectric support element (11).

23. The antenna arrangement according to any of the previous claims, wherein the patch (10) is provided by etching, printing or screen printing of the conductive material on the support element (11).

24. The antenna arrangement according to any of the previous claims, wherein the patch (10) and a ground plane (15) are separated by a dielectric substrate.

25. The antenna arrangement according to any of the previous claims, wherein the support element (11) is used as the dielectric substrate, where the ground plane (15) is arranged on a first side of the substrate and the patch (10) is arranged on a second side of the substrate.

26. The antenna arrangement according to any of the previous claims, wherein the shape of the patch is a circular, an elliptical, a dipole, a circular ring, a square, a rectangular or a triangular shape.

27. A wireless communication apparatus comprising the antenna arrangement according to any of claims 1-26.

28. The wireless communication apparatus according to claim 27, wherein the wireless communication apparatus is portable.

29. The wireless communication apparatus according to claim 27 or 28, wherein the wireless communication apparatus is a computer, a portable radio communication equipment, a mobile radio terminal, a pager, a communicator, an electronic organizer, a personal digital assistant, a handheld device or a Smartphone.
